(19) United States
(12) Patent Application Publication
(10) Pub. No.: US 2026/0251234 A1
(43) Pub. Date: Aug. 27, 2026

(54) MANAGEMENT SYSTEM AND MANAGEMENT METHOD

(71) Applicant: Azbil Corporation, Tokyo (JP)

(72) Inventors: Fumiaki YAMASAKI, Tokyo (JP); Masato TANAKA, Tokyo (JP); Ryouta OGATA, Tokyo (JP); Norio OOKUBO, Tokyo (JP); Mamoru KAGOURA, Tokyo (JP); Soichiro YANASE, Tokyo (JP); Kouichirou MURATA, Tokyo (JP); Masaki SAKAI, Tokyo (JP)

(73) Assignee: Azbil Corporation, Tokyo (JP)

(21) Appl. No.: 19/408,296

(22) Filed: Dec. 3, 2025

(30) Foreign Application Priority Data
Feb. 26, 2025 (JP) 2025-028668

(51) Int. Cl. F16K 37/00

(52) U.S. Cl. CPC F16K 37/0041

(57) ABSTRACT

A management system includes: a management sequence memory portion that stores, for each valve or each combination of valves to be managed among ON-OFF valves controlled by a sequence to be managed, definition information of a deviation in operation timing and a prescribed value of a deviation for an ON-OFF valve to be managed; an operation result information acquisition portion that acquires an actual value of an opening or closing time point of the valve to be managed; time difference determination portions that calculate a deviation in operation timing for each valve or each combination of valves to be managed based on the definition information and an actual value of the opening or closing time point, and determines whether a deviation in operation timing calculated is within a range of the prescribed value; and a determination result output portion that outputs a determination result by the time difference determination portions.

### CROSS-REFERENCE TO RELATED APPLICATION

This application claims the priority benefit of Japan application serial no. 2025-028668, filed on Feb. 26, 2025. The entirety of the above-mentioned patent application is hereby incorporated by reference herein and made a part of this specification.

### BACKGROUND

### Technical Field

The disclosure relates to technology for supporting maintenance work, and particularly relates to a management system and management method that realize support for efficient maintenance work of ON-OFF valves.

### Description of Related Art

Valves used in petrochemical plants and the like (e.g., the control valve in FIG. 16) require particular attention to safety, and therefore periodic maintenance is performed. The control valve shown in FIG. 16 includes a valve body 100 that opens and closes a passage through which fluid flows, a positioner 101 that converts an input electrical signal to air pressure, and an actuator 102 that operates the valve body 100 according to the air pressure supplied from the positioner 101.

In order to improve valve maintenance work efficiency in plants where a plurality of valves such as those shown in FIG. 16 are installed, technologies have been proposed including technology for detecting the occurrence of stick slip in sliding parts of valves (see Patent Document 1, Japanese Patent No. 3254624), technology for determining hunting states of valves (see Patent Document 2, Japanese Patent No. 6200309), and technology for detecting scale adhesion to valves (see Patent Document 3, Japanese Patent No. 6216633).

On the other hand, as a different type of valve from control valves that can continuously change their opening degree, there are ON-OFF valves that can only take two positions of opening degree: fully open/fully closed. The ON-OFF valve 200 shown in FIG. 17 uses a ball valve, and has a structure in which a ball 201, which is a valve body, is sandwiched by seat rings 202 called ball seats, and the valve can be opened or closed by rotating a stem (valve rod) 203 90 degrees with an actuator 204. Further, depending on the type, there are some other than 90 degrees. Moreover, not only ball valves but also those using butterfly valves, plug valves, gate valves, diaphragm valves, and the like are available. In order to improve the maintenance work efficiency of ON-OFF valves, a technology has been proposed that uses the dead zone time from the change time point of actuator pressure to the operation time point of the ON-OFF valve when the ON-OFF valve is fully closed as a diagnostic indicator (see Patent Document 4, Japanese Patent No. 7417376).

A plurality of ON-OFF valves are used in plants, and it is necessary and important to efficiently diagnose the plurality of ON-OFF valves. That is, depending on the plant, hundreds of ON-OFF valves may be used, and there is a priority of ON-OFF valves that should receive particular attention in daily inspection. Further, in sequence control, malfunctions of ON-OFF valves may directly lead to quality degradation of products manufactured in the plant, but with conventional technology, management of ON-OFF valves in sequence control cannot be said to be sufficient, and improvement is required.

The disclosure provides a management system and management method that may efficiently diagnose and manage a plurality of ON-OFF valves used in sequence control.

### SUMMARY

The management system of the disclosure is a management system including: a management sequence memory portion configured to store, for each valve to be managed or for each combination of valves to be managed among ON-OFF valves controlled by a sequence to be managed, definition information of a deviation in operation timing and a prescribed value of a deviation for an ON-OFF valve to be managed; an operation result information acquisition portion configured to acquire an actual value of an opening or closing time point of the valve to be managed; a time difference determination portion configured to calculate a deviation in operation timing for each valve to be managed or for each combination of valves to be managed based on the definition information and an actual value of the opening or closing time point, and to determine whether a deviation in operation timing calculated is within a range of the prescribed value; and a determination result output portion configured to output a determination result by the time difference determination portion.

Further, in one configuration example of the management system of the disclosure, the time difference determination portion is a regular time difference determination portion that calculates, as the deviation in operation timing, a deviation between a time point when a valve should operate and an actual value of a time point when the valve operated for each valve to be managed and determines whether a deviation in operation timing calculated is within a range of the prescribed value.

Further, in one configuration example of the management system of the disclosure, the deviation in operation timing is at least one of a deviation between a time point when a valve should open and an actual value of a time point when the valve opened, and a deviation between a time point when a valve should close and an actual value of a time point when the valve closed.

Further, in one configuration example of the management system of the disclosure, the time difference determination portion is an actual time difference determination portion that calculates, as the deviation in operation timing, a deviation in operation timing between a first valve and a second valve for each combination of the first valve and the second valve to be managed and determines whether a deviation in operation timing calculated is within a range of the prescribed value.

Further, in one configuration example of the management system of the disclosure, the deviation in operation timing is at least one of a deviation between a time point when the first valve opened and a time point when the second valve opened, a deviation between a time point when the first valve opened and a time point when the second valve closed, a deviation between a time point when the first valve closed and a time point when the second valve opened, and a deviation between a time point when the first valve closed and a time point when the second valve closed.

Further, in one configuration example of the management system of the disclosure, when deviations in operation timing among three or more valves are to be managed, the management sequence memory portion stores the definition information and the prescribed value for each of different combinations of the first valve and the second valve included in the three or more valves, and the actual time difference determination portion calculates a deviation in operation timing for each of the different combinations of the first valve and the second valve included in the three or more valves, and determines whether a deviation in operation timing calculated is within a range of a corresponding prescribed value.

Further, in one configuration example of the management system of the disclosure, the time difference determination portion includes two portions: a regular time difference determination portion that calculates, as the deviation in operation timing, a deviation between a time point when a valve should operate and an actual value of a time point when the valve operated for each valve to be managed, and determines whether a deviation in operation timing calculated is within a range of the prescribed value; and an actual time difference determination portion that calculates, as the deviation in operation timing, a deviation in operation timing between a first valve and a second valve for each combination of the first valve and the second valve to be managed, and determines whether a deviation in operation timing calculated is within a range of the prescribed value, and the determination result output portion displays at least one of a determination result by the regular time difference determination portion and a determination result by the actual time difference determination portion, and displays a determination result where the deviation in operation timing is outside a range of the prescribed value in a different format from a determination result where the deviation in operation timing is within the range of the prescribed value.

Further, in one configuration example of the management system of the disclosure, the determination result output portion displays information of a valve where the deviation in operation timing is outside a range of the prescribed value in both a determination by the regular time difference determination portion and a determination by the actual time difference determination portion, in a different format from information of a valve where the deviation in operation timing is within a range of the prescribed value in at least one of a determination by the regular time difference determination portion and a determination by the actual time difference determination portion.

Further, in one configuration example of the management system of the disclosure, the management sequence memory portion stores importance information of the deviation in operation timing together with the definition information and the prescribed value for each valve to be managed or for each combination of valves to be managed, and when a plurality of determination results where the deviation in operation timing is outside a range of the prescribed value are obtained, the determination result output portion displays a determination result so that an importance of the deviation in operation timing is capable of being understood based on the importance information.

Further, the management method of the disclosure is a management method that includes: a first step of acquiring an actual value of an opening or closing time point of an ON-OFF valve to be managed among ON-OFF valves controlled by a sequence to be managed; a second step of referring to a management sequence memory portion that stores, for each valve to be managed or for each combination of valves to be managed, definition information of a deviation in operation timing and a prescribed value of a deviation for the valve to be managed, and calculating a deviation in operation timing for each valve to be managed or for each combination of valves to be managed based on the definition information and the actual value of the opening or closing time point; a third step of determining whether a deviation in operation timing calculated in the second step is within a range of the prescribed value; and a fourth step of outputting a determination result by the third step.

### BRIEF DESCRIPTION OF THE DRAWINGS

FIG. 1 is a block diagram showing a configuration of a management system according to an example of the disclosure.

FIG. 2 is a flowchart describing operation of a management system according to an example of the disclosure.

FIG. 3 is a diagram describing deviation in opening operation timing of an ON-OFF valve.

FIG. 4 is a diagram describing deviation in closing operation timing of an ON-OFF valve.

FIG. 5 is a diagram describing deviation in open-open operation timing of an ON-OFF valve.

FIG. 6 is a diagram describing deviation in open-close operation timing of an ON-OFF valve.

FIG. 7 is a diagram describing deviation in close-open operation timing of an ON-OFF valve.

FIG. 8 is a diagram describing deviation in close-close operation timing of an ON-OFF valve.

FIG. 9 is a diagram showing a display example by the determination result output portion according to an example of the disclosure.

FIG. 10 is a diagram showing another display example by the determination result output portion according to an example of the disclosure.

FIG. 11 is a diagram showing another display example by the determination result output portion according to an example of the disclosure.

FIG. 12 is a diagram showing another display example by the determination result output portion according to an example of the disclosure.

FIG. 13 is a diagram describing effects of a determination formula with the absolute value symbol removed in an example of the disclosure.

FIG. 14 is a diagram describing effects of a determination formula with the absolute value symbol removed in an example of the disclosure.

FIG. 15 is a block diagram showing a configuration example of a computer that realizes the management system according to an example of the disclosure.

FIG. 16 is a diagram showing an example of a control valve.

FIG. 17 is a diagram showing an example of an ON-OFF valve.

### DESCRIPTION OF THE EMBODIMENTS

According to the disclosure, by providing the management sequence memory portion, the operation result information acquisition portion, the time difference determination portion, and the determination result output portion, a plurality of ON-OFF valves used in sequence control may be efficiently diagnosed and managed. As a result, the disclosure may reduce the possibility that the quality of products manufactured in a plant may deteriorate due to deviation in operation timing of ON-OFF valves.

Further, in the disclosure, the time difference determination portion calculates deviation between a time point at which a valve should operate and an actual value of a time point at which the valve operated for each valve to be managed, and determines whether the deviation in operation timing calculated is within a range of prescribed value, thereby enabling diagnosis and management of the deviation in operation timing of individual valves used in sequence control.

Further, in the disclosure, the time difference determination portion calculates a deviation in operation timing between a first valve and a second valve for each combination of the first valve and the second valve, which are management targets, and determines whether the deviation in operation timing calculated is within a range of prescribed value, thereby enabling diagnosis and management of the deviation in operation timing between a plurality of valves used in sequence control.

Further, in the disclosure, the actual time difference determination portion calculates a deviation in operation timing for each of different combinations of the first valve and the second valve included in three or more valves, and determines whether the deviation in operation timing calculated is within a range of a corresponding prescribed value, thereby enabling diagnosis and management of the deviation in operation timing among three or more valves.

Further, in the disclosure, by displaying a determination result in which the deviation in operation timing is outside a range of prescribed value in a different format from a determination result in which the deviation in operation timing is within a range of prescribed value, the determination result in which the deviation in operation timing is outside a range of prescribed value may be easily recognized.

Further, in the disclosure, by displaying information of valves in which the deviation in operation timing is outside a range of prescribed value in both determination by the regular time difference determination portion and determination by the actual time difference determination portion in a different format from information of valves in which the deviation in operation timing is within a range of prescribed value in at least one of determination by the regular time difference determination portion and determination by the actual time difference determination portion, priority of events that an operator should respond to may be notified.

Further, in the disclosure, in the case of obtaining a plurality of determination results in which the deviation in operation timing is outside a range of prescribed value, by displaying the determination results so that importance of the deviation in operation timing is understandable, events with high importance may be notified to an operator.

### [Principle of Invention 1]

The inventor found that there is room for improvement in that the operation timing of ON-OFF valves in continuous processes (polymer/polymerization system equipment, PSA (Pressure Swing Adsorption) equipment, catalyst/ion exchange system equipment, etc.) and batch processes of plants is managed mainly individually by timers of higher-level systems (DCS (Distributed Control System) or sequencers), or in multiple forms (group units, unit units, processing units, batch units) that combine individual units.

Thus, the inventor focused on using the manufacturing operation timing of a plurality of ON-OFF valves as a management indicator (diagnostic indicator) as the essence of sequences. Specifically, this uses deviation (e.g., time difference) as a sequence as an indicator, which is an indicator directly linked to, for example, collapse of pressure balance that should be satisfied as a manufacturing process, and further quality deterioration accompanying collapse of manufacturing process conditions.

### [Principle of Invention 2]

There are ON-OFF valve A and ON-OFF valve B, and for example, in the case where the timing of ON-OFF valve A closing and the timing of ON-OFF valve B opening need to match, there is no problem if each of the valve A and the valve B operates appropriately with respect to timer management, but if the timing of the valve B opening is delayed outside the management range, this is considered a serious alert event. It is noted that similar situations may occur not only with the timing of a closing valve and an opening valve, but also with an opening valve and an opening valve, a closing valve and a closing valve, or an opening valve and a closing valve.

In this case, if the timing of the valve A closing is also delayed, thereby reducing the operation interval between the valve A and the valve B, the severity as a defect in product manufacturing may not be high. By providing management indicators (diagnostic indicators) that include such perspectives, the priority of events that operators should respond to may be improved to be more appropriate.

### EXAMPLES

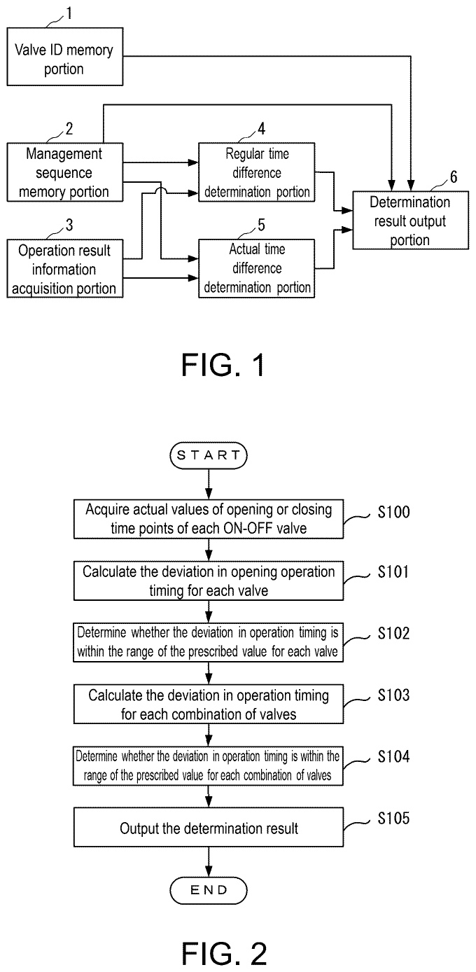

Examples of the disclosure will be described below with reference to the drawings. FIG. 1 is a block diagram showing the configuration of a management system according to an example of the disclosure. This example corresponds to the above principles 1 and 2 of the invention.

The management system includes a valve ID memory portion 1 that stores IDs of ON-OFF valves included in a sequence to be managed, a management sequence memory portion 2 configured to store definition information of the deviation in operation timing and a prescribed value of deviation for ON-OFF valves to be managed among ON-OFF valves controlled by a sequence to be managed, for each valve to be managed or each combination of valves to be managed, an operation result information acquisition portion 3 that acquires actual values of opening or closing time points of valves to be managed, a regular time difference determination portion 4 that calculates, as the deviation in operation timing, a deviation between a time point when a valve should operate and an actual value of a time point when the valve operated for each valve to be managed, and determines whether the deviation in operation timing calculated is within a range of prescribed value, an actual time difference determination portion 5 that calculates, as the deviation in operation timing, the deviation in operation timing between a first valve and a second valve for each combination of the first valve and the second valve to be managed, and determines whether the deviation in operation timing calculated is within a range of prescribed value, and a determination result output portion 6 that outputs determination results.

FIG. 2 is a flowchart describing the operation of the management system of this example. In the valve ID memory portion 1, IDs of ON-OFF valves that particularly need management of the deviation in operation timing are registered in advance among a plurality of ON-OFF valves that are control targets in a sequence to be managed. In this example, assuming there are 26 valves in a plant, unique IDs “A”, “B”, “C”, . . . , “M”, . . . , “X”, “Y”, “Z” are assigned to these 26 valves in advance. In particular, valves with valve IDs “A”, “B”, “C” are ON-OFF valves to be managed, and these IDs “A”, “B”, “C” are registered in advance in the valve ID memory portion 1.

In the management sequence memory portion 2, definition information of the deviation in operation timing that needs to be managed and prescribed values of deviation are registered in advance for each valve ID or each combination of valve IDs for ON-OFF valves to be managed. The definition information of the deviation in operation timing defines the deviation in operation timing of ON-OFF valves to be managed by mathematical formulas for each valve ID or each combination of valve IDs.

For example, regarding the example of managing the deviation in operation timing of ON-OFF valves for each valve as described in the above principle 1 of the invention, as definition information of the deviation in operation timing, there are two types of mathematical formulas: a mathematical formula that defines deviation between a time point when a valve should open and an actual value of a time point when the valve opened (hereinafter, deviation in opening operation timing), and a mathematical formula that defines deviation between a time point when a valve should close and an actual value of a time point when the valve closed (hereinafter, deviation in closing operation timing).

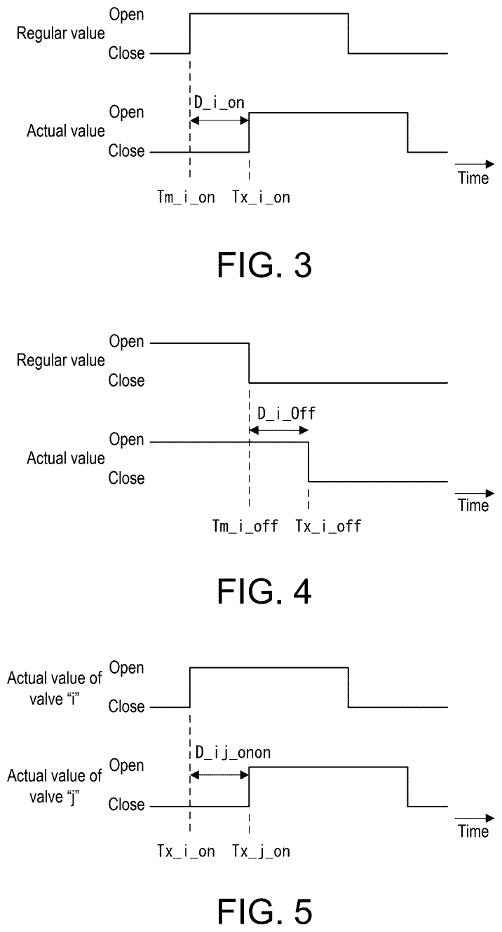

Deviation in opening operation timing D_i_on of an ON-OFF valve with valve ID “i” (i is any ID of “A”, “B”, “C”) is defined as in formula (1) (FIG. 3).

$$D\_i \_on = \vert Tx\_i \_on - Tm\_i \_on \vert \qquad ( 1 )$$

Deviation in closing operation timing D_i_off of an ON-OFF valve with valve ID “i” is defined as in formula (2) (FIG. 4).

$$D\_i \_off = \vert Tx\_i \_off - Tm\_i \_off \vert \qquad ( 2 )$$

In formula (1) and formula (2), Tm_i_on is the time point at which the ON-OFF valve with valve ID “i” should open, and Tm_i_off is the time point at which the ON-OFF valve with valve ID “i” should close. Tm_i_on and Tm_i_off are fixed values and are registered in advance for each valve ID “i”. On the other hand, Tx_i_on is the actual value of the time point at which the ON-OFF valve with valve ID “i” opened, and Tx_i_off is the actual value of the time point at which the ON-OFF valve with valve ID “i” closed. The acquisition method for Tx_i_on and Tx_i_off will be described later. Tm_i_on, Tm_i_off, Tx_i_on, and Tx_i_off are all defined as elapsed time from the sequence start time point.

It is noted that formula (1) and formula (2) are examples, and the absolute value symbol may be removed as shown in formula (3) and formula (4).

$$D\_i \_on = Tx\_i \_on - Tm\_i \_on \qquad ( 3 )$$

$$D\_i \_off = Tx\_i \_off - Tm\_i \_off \qquad ( 4 )$$

As described in the above principle 2 of the invention, regarding the example of managing the deviation in operation timing of ON-OFF valves for each combination of valves, as definition information for the deviation in operation timing, there are four types: a formula that defines the deviation between the time point at which the first valve opened and the time point at which the second valve opened (hereinafter abbreviated as deviation in open-open operation timing), a formula that defines the deviation between the time point at which the first valve opened and the time point at which the second valve closed (hereinafter abbreviated as deviation in open-close operation timing), a formula that defines the deviation between the time point at which the first valve closed and the time point at which the second valve opened (hereinafter abbreviated as deviation in close-open operation timing), and a formula that defines the deviation between the time point at which the first valve closed and the time point at which the second valve closed (hereinafter abbreviated as deviation in close-close operation timing).

The deviation in open-open operation timing D_ij_onon between the first ON-OFF valve with valve ID “i” (i is any ID of “A”, “B”, “C”) and the second ON-OFF valve with valve ID “j” (j is any ID of “A”, “B”, “C”, where i≠j) is defined as shown in formula (5) (FIG. 5).

$$D\_ij \_onon = \vert Tx\_i \_on - Tx\_j \_on \vert \qquad ( 5 )$$

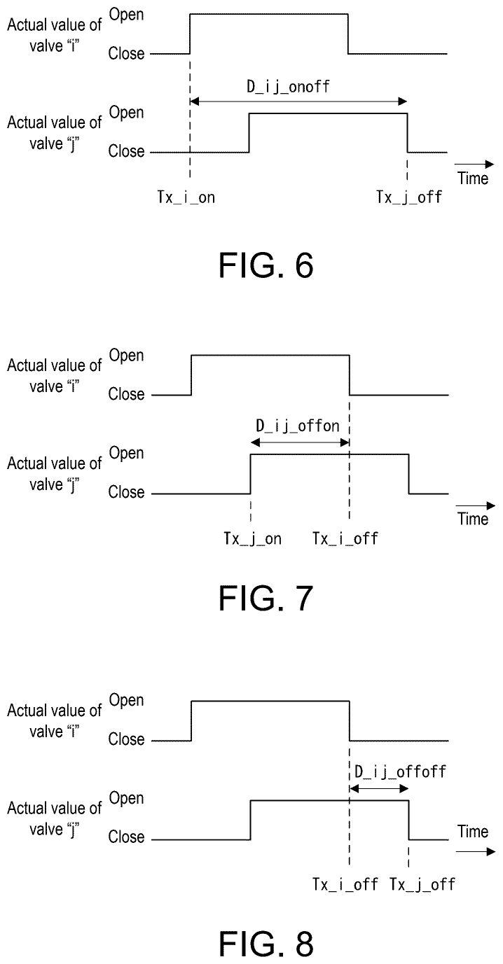

The deviation in open-close operation timing D_ij_onoff between the first valve and the second valve is defined as shown in formula (6) (FIG. 6).

$$D\_ij \_onoff = \vert Tx\_i \_on - Tx\_j \_off \vert \qquad ( 6 )$$

The deviation in close-open operation timing D_ij_offon between the first valve and the second valve is defined as shown in formula (7) (FIG. 7).

$$D\_ij \_offon = \vert Tx\_i \_off - Tx\_j \_on \vert \qquad ( 7 )$$

The deviation in close-close operation timing D_ij_offoff between the first valve and the second valve is defined as shown in formula (8) (FIG. 8).

$$D\_ij \_offoff = \vert Tx\_i \_off - Tx\_j \_off \vert \qquad ( 8 )$$

Tx_j_on is the actual value at the time point when the ON-OFF valve of valve ID “j” opens, and Tx_j_off is the actual value at the time point when the ON-OFF valve of valve ID “j” closes. Both Tx_j_on and Tx_j_off are defined as elapsed time from the sequence start time point.

It is noted that formulas (5) to (8) are examples, and the absolute value symbol may be removed as shown in formulas (9) to (12).

$$D\_ij \_onon = Tx\_i \_on - Tx\_j \_on \qquad ( 9 )$$

$$D\_ij \_onoff = Tx\_i \_on - Tx\_j \_off \qquad ( 10 )$$

$$D\_ij \_offon = Tx\_i \_off - Tx\_j \_on \qquad ( 11 )$$

$$D\_ij \_offoff = Tx\_i \_off - Tx\_j \_off \qquad ( 12 )$$

Further, in the management sequence memory portion 2, prescribed values of the deviation in operation timing are registered in advance for each valve ID or for each combination of valve IDs. For formula (1) or formula (3), a prescribed value (upper limit value) ΔT1H_i_on and a prescribed value (lower limit value) ΔT1L_i_on of D_i_on are registered in advance for each valve ID “i”. For formula (2) or formula (4), a prescribed value (upper limit value) ΔT1H_i_Off and a prescribed value (lower limit value) ΔT1L_i_off of D_i_off are registered in advance for each valve ID “i”.

For formula (5) or formula (9), a prescribed value (upper limit value) ΔT2H_ij_onon and a prescribed value (lower limit value) ΔT2L_ij_onon of D_ij_onon are registered in advance for each combination of valve IDs “i” and “j”. For formula (6) or formula (10), a prescribed value (upper limit value) ΔT2H_ij_onoff and a prescribed value (lower limit value) ΔT2L_ij_onoff of D_ij_onoff are registered in advance for each combination of valve IDs “i” and “j”. For formula (7) or formula (11), a prescribed value (upper limit value) ΔT2H_ij_offon and a prescribed value (lower limit value) ΔT2L_ij_offon of D_ij_offon are registered in advance for each combination of valve IDs “i” and “j”. For formula (8) or formula (12), a prescribed value (upper limit value) ΔT2H_ij_offoff and a prescribed value (lower limit value) ΔT2L_ij_offoff of D_ij_offoff are registered in advance for each combination of valve IDs “i” and “j”.

In formulas (5) to (8) and formulas (9) to (12), examples were described in which the deviation in operation timing was defined for combinations of two valves, but the deviation in operation timing among three or more valves may also be defined. In this case, among the three or more valves, by setting any of formulas (5) to (8) and formulas (9) to (12) for each combination of two valves for which the deviation in operation timing is desired to be defined, the deviation in operation timing among three or more valves may be defined by a combination of a plurality of formulas.

The operation result information acquisition portion 3 acquires actual values of opening or closing time points of each ON-OFF valve (step S100 in FIG. 2). Each ON-OFF valve includes a limit switch or opening detector that detects an open state, and a limit switch or opening detector that detects a closed state, and includes an answerback function that indicates the open state or closed state.

An open signal that notifies that the limit switch detecting the open state of the ON-OFF valve has turned on and a close signal that notifies that the limit switch detecting the closed state of the ON-OFF valve has turned on are transmitted from a controller that controls the ON-OFF valve to the operation result information acquisition portion 3. At this time, the controller transmits the open signal or close signal with the ID of the ON-OFF valve added thereto.

The operation result information acquisition portion 3 sets the elapsed time from the sequence start time point to the time point when the open signal is received as the actual value of the time point when the ON-OFF valve opened. Further, the operation result information acquisition portion 3 sets the elapsed time from the sequence start time point to the time point when the close signal is received as the actual value of the time point when the ON-OFF valve closed.

It is noted that information of the sequence to be managed is registered in advance in the management sequence memory portion 2, and information of the sequence start time point (absolute time) is included in this information. Thus, the operation result information acquisition portion 3 may measure the elapsed time from the sequence start time point by a timer function. Alternatively, the operation result information acquisition portion 3 may acquire information of the sequence start time point from a control system that performs sequence control.

Next, the regular time difference determination portion 4 calculates at least one of the deviation in opening operation timing and the deviation in closing operation timing for each valve ID, based on the definition information stored in the management sequence memory portion 2 and the actual values of the opening or closing time points acquired by the operation result information acquisition portion 3 (step S101 in FIG. 2). Then, the regular time difference determination portion 4 determines whether the deviation in operation timing calculated is within the range of the prescribed value of the deviation stored in the management sequence memory portion 2 for each valve ID (step S102 in FIG. 2).

For example, in the case of the actual value of the time point when the ON-OFF valve with valve ID “i” opened being Tx_i_on, the regular time difference determination portion 4 calculates the deviation in opening operation timing D_i_on of this ON-OFF valve by formula (1) or formula (3). The regular time difference determination portion 4 determines that D_i_on is outside the range of the prescribed values ΔT1H_i_on, ΔT1L_i_on in the case of formulas (13) to (16) being satisfied.

$$D\_i \_on = \vert Tx\_i \_on - Tm\_i \_on \vert > Δ T1H\_i \_on \qquad ( 13 )$$

$$D\_i \_on = \vert Tx\_i \_on - Tm\_i \_on \vert < Δ T1L\_i \_on \qquad ( 14 )$$

$$D\_i \_on = Tx\_i \_on - Tm\_i \_on > Δ T1H\_i \_on \qquad ( 15 )$$

$$D\_i \_on = Tx\_i \_on - Tm\_i \_on < Δ T1L\_i \_on \qquad ( 16 )$$

Which formula to use among formulas (13) to (16) is determined in advance. Further, two or more formulas among formulas (13) to (16) may be used. In the case of using two or more formulas, D_i_on is determined to be outside the range of the prescribed values in the case of any one formula being satisfied. Further, in formulas (13) and (15), the prescribed value (upper limit value) ΔT1H_i_on is described as the same value, but it goes without saying that the prescribed values may differ between formulas (13) and (15). Similarly, in formulas (14) and (16), the prescribed value (lower limit value) ΔT1L_i_on is described as the same value, but it goes without saying that the prescribed values may differ between formulas (14) and (16).

Further, in the case of the actual value at the time point of the ON-OFF valve with valve ID “i” closing being Tx_i_off, the regular time difference determination portion 4 calculates the deviation in closing operation timing D_i_off of this ON-OFF valve by formula (2) or formula (4). The regular time difference determination portion 4 determines that D_i_off is outside the range of the prescribed values ΔT1H_i_off, ΔT1L_i_off in the case of formulas (17) to (20) being satisfied.

$$D\_i \_off = \vert Tx\_i \_off - Tm\_i \_off \vert > Δ T1H\_i \_off \qquad ( 17 )$$

$$D\_i \_off = \vert Tx\_i \_off - Tm\_i \_off \vert < Δ T1L\_i \_off \qquad ( 18 )$$

$$D\_i \_off = Tx\_i \_off - Tm\_i \_off > Δ T1H\_i \_off \qquad ( 19 )$$

$$D\_i \_off = Tx\_i \_off - Tm\_i \_off < Δ T1L\_i \_off \qquad ( 20 )$$

Which formula to use among formulas (17) to (20) is determined in advance. Further, two or more formulas among formulas (17) to (20) may be used. In the case of using two or more formulas, D_i_off is determined to be outside the range of the prescribed values in the case of any one formula being satisfied. Further, in formulas (17) and (19), the prescribed value (upper limit value) ΔT1H_i_off is described as the same value, but it goes without saying that the prescribed values may differ between formulas (17) and (19). Similarly, in formulas (18) and (20), the prescribed value (lower limit value) ΔT1L_i_off is described as the same value, but it goes without saying that the prescribed values may differ between formulas (18) and (20).

On the other hand, the actual time difference determination portion 5 calculates at least one of the deviation in open-open operation timing, the deviation in open-close operation timing, the deviation in close-open operation timing, and the deviation in close-close operation timing for each defined combination of valve IDs, based on the definition information stored in the management sequence memory portion 2 and the actual values of the opening or closing time points acquired by the operation result information acquisition portion 3 (FIG. 2 step S103). Then, the regular time difference determination portion 4 determines whether the deviation in operation timing calculated is within the range of the prescribed value of the deviation stored in the management sequence memory portion 2 for each defined combination of valve IDs (FIG. 2 step S104).

In the case of the actual value at the time point the ON-OFF valve of valve ID “i” opened being Tx_i_on, the actual value at the time point it closed being Tx_i_off, the actual value at the time point the ON-OFF valve of valve ID “j” opened being Tx_j_on, and the actual value at the time point it closed being Tx_j_off, the actual time difference determination portion 5 calculates the deviation in open-open operation timing D_ij_onon by formula (5) or formula (9) (step S103).

The actual time difference determination portion 5 determines that D_ij_onon is outside the range of the prescribed values ΔT2H_ij_onon, ΔT2L_ij_onon in the case of formulas (21) to (24) being satisfied (step S104).

$$D\_ij \_onon = \vert Tx\_i \_on - Tx\_j \_on \vert > Δ T2H\_ij \_onon \qquad ( 21 )$$

$$D\_ij \_onon = \vert Tx\_i \_on - Tx\_j \_on \vert < Δ T2L\_ij \_onon \qquad ( 22 )$$

$$D\_ij \_onon = Tx\_i \_on - Tx\_j \_on > Δ T2H\_ij \_onon \qquad ( 23 )$$

$$D\_ij \_onon = Tx\_i \_on - Tx\_j \_on < Δ T2L\_ij \_onon \qquad ( 24 )$$

Which formula to use among formulas (21) to (24) is determined in advance. Further, two or more formulas among formulas (21) to (24) may be used. In the case of using two or more formulas, D_ij_onon is determined to be outside the range of the prescribed values in the case of any one formula being satisfied. Further, in formulas (21) and (23), the prescribed value (upper limit value) ΔT2H_ij_onon is described as the same value, but it goes without saying that the prescribed values may differ between formulas (21) and (23). Similarly, in formulas (22) and (24), the prescribed value (lower limit value) ΔT2L_ij_onon is described as the same value, but it goes without saying that the prescribed values may differ between formulas (22) and (24).

The actual time difference determination portion 5 calculates the deviation in open-close operation timing D_ij_onoff by formula (6) or formula (10) (step S103). The actual time difference determination portion 5 determines that D_ij_onoff is outside the range of the prescribed values ΔT2H_ij_onoff, ΔT2L_ij_onoff in the case of formulas (25) to (28) being satisfied (step S104).

$$D\_ij \_onoff = \vert Tx\_i \_on - Tx\_j \_off \vert > Δ T2H\_ij \_onoff \qquad ( 25 )$$

$$D\_ij \_onoff = \vert Tx\_i \_on - Tx\_j \_off \vert < Δ T2L\_ij \_onoff \qquad ( 26 )$$

$$D\_ij \_onoff = Tx\_i \_on - Tx\_j \_off > Δ T2H\_ij \_onoff \qquad ( 27 )$$

$$D\_ij \_onoff = Tx\_i \_on - Tx\_j \_off < Δ T2L\_ij \_onoff \qquad ( 28 )$$

Which formula to use among formulas (25) to (28) is determined in advance. Further, two or more formulas among formulas (25) to (28) may be used. In the case of using two or more formulas, D_ij_onoff is determined to be outside the range of the prescribed values in the case of any one formula being satisfied. Further, in formulas (25) and (27), the prescribed value (upper limit value) ΔT2H_ij_onoff is described as the same value, but it goes without saying that the prescribed values may differ between formulas (25) and (27). Similarly, in formulas (26) and (28), the prescribed value (lower limit value) ΔT2L_ij_onoff is described as the same value, but it goes without saying that the prescribed values may differ between formulas (26) and (28).

The actual time difference determination portion 5 calculates the deviation in close-open operation timing D_ij_offon according to formula (7) or formula (11) (step S103). The actual time difference determination portion 5 determines that D_ij_offon is outside the range of the prescribed values ΔT2H_ij_offon, ΔT2L_ij_offon in the case of formulas (29) to (32) being satisfied (step S104).

$$D\_ij \_offon = \vert Tx\_i \_off - Tx\_j \_on \vert > Δ T2H\_ij \_offon \qquad ( 29 )$$

$$D\_ij \_offon = \vert Tx\_i \_off - Tx\_j \_on \vert < Δ T2L\_ij \_offon \qquad ( 30 )$$

$$D\_ij \_offon = Tx\_i \_off - Tx\_j \_on > Δ T2H\_ij \_offon \qquad ( 31 )$$

$$D\_ij \_offon = Tx\_i \_off - Tx\_j \_on < Δ T2L\_ij \_offon \qquad ( 32 )$$

Which formula to use among formulas (29) to (32) is determined in advance. Further, two or more formulas among formulas (29) to (32) may be used. In the case of using two or more formulas, D_ij_offon is determined to be outside the range of the prescribed values in the case of any one formula being satisfied. Further, in formulas (29) and (31), the prescribed value (upper limit value) ΔT2H_ij_offon is described as the same value, but it goes without saying that the prescribed values in formulas (29) and (31) may differ. Similarly, in formulas (30) and (32), the prescribed value (lower limit value) ΔT2L_ij_offon is described as the same value, but it goes without saying that the prescribed values may differ between formulas (30) and (32).

The actual time difference determination portion 5 calculates the deviation in close-close operation timing D_ij_offoff according to formula (8) or formula (12) (step S103). The actual time difference determination portion 5 determines that D_ij_offoff is outside the range of the prescribed values ΔT2H_ij_offoff, ΔT2L_ij_offoff in the case of formulas (33) to (36) being satisfied (step S104).

$$D\_ij \_offoff = \vert Tx\_i \_off - Tx\_j \_off \vert > Δ T2H\_ij \_offoff \qquad ( 33 )$$

$$D\_ij \_offoff = \vert Tx\_i \_off - Tx\_j \_off \vert < Δ T2L\_ij \_offoff \qquad ( 34 )$$

$$D\_ij \_offoff = Tx\_i \_off - Tx\_j \_off > Δ T2H\_ij \_offoff \qquad ( 35 )$$

$$D\_ij \_offoff = Tx\_i \_off - Tx\_j \_off < Δ T2L\_ij \_offoff \qquad ( 36 )$$

Which formula to use among formulas (33) to (36) is determined in advance. Further, two or more formulas among formulas (33) to (36) may be used. In the case of using two or more formulas, D_ij_offoff is determined to be outside the range of the prescribed values in the case of any one formula being satisfied. Further, in formulas (33) and (35), the prescribed value (upper limit value) ΔT2H_ij_offoff is described as the same value, but it goes without saying that the prescribed values may differ between formulas (33) and (35). Similarly, in formulas (34) and (36), the prescribed value (lower limit value) ΔT2L_ij_offoff is described as the same value, but it goes without saying that the prescribed values may differ between formulas (34) and (36).

In formulas (21) to (36), examples of determining combinations of two valves have been described, but in the case of managing the deviations in operation timing among three or more valves as management targets, the deviations in operation timing among three or more valves may be determined using a plurality of determination formulas with different valve combinations (different combinations of i and j). In the case of using a plurality of determination formulas with different valve combinations, the deviation in operation timing is determined to be outside the range of prescribed values in the case of any one formula being satisfied.

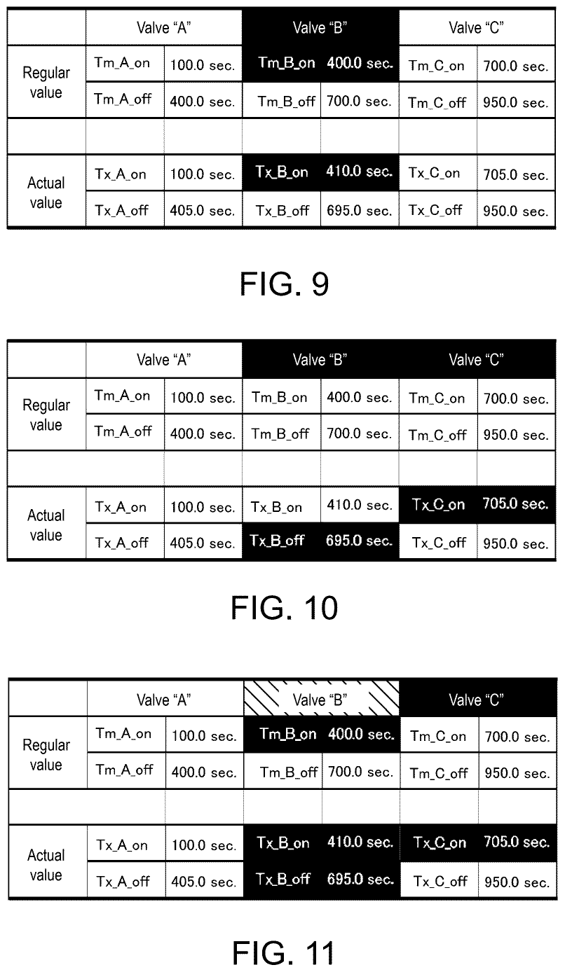

Next, the determination result output portion 6 outputs at least one of the determination result of the regular time difference determination portion 4 and the determination result of the actual time difference determination portion 5 (FIG. 2 step S105). FIG. 9 is a diagram showing a display example of the determination result of the regular time difference determination portion 4. The determination result output portion 6 displays the normal value Tm_i_on (i is any of “A”, “B”, “C”) of the time point at which each valve of valve IDs “A”, “B”, “C” should open, the normal value Tm_i_off of the time point at which each valve should close, the actual value Tx_i_on of the time point at which each valve opened, and the actual value Tx_i_off of the time point at which each valve closed. In the example of FIG. 9, the prescribed value ΔT1H_i_on of the deviation in opening operation timing D_i_on and the prescribed value ΔT1H_i_off of the deviation in closing operation timing D_i_off are set to 8.0 sec.

The regular time difference determination portion 4 determines that the deviation in opening operation timing D_B_on of the valve with valve ID “B” is outside the range of the prescribed value ΔT1H_B_on=8.0 sec. by the determination formulas of formula (13) and formula (17).

Thus, the determination result output portion 6 displays the ID “B” of the valve determined to have the deviation in operation timing outside the range of the prescribed value, and the normal value Tm_B_on=400.0 sec, and actual value Tx_B_on=410.0 sec. used for calculating this deviation in operation timing, in a format different from the determination result where the deviation in operation timing is within the range of the prescribed value (white on black background in the example of FIG. 9). By such display distinction, an operator viewing the display of FIG. 9 may recognize that the deviation in opening operation timing of the valve with valve ID “B” is outside the range of the prescribed value. FIG. 9 is one example, and the deviation in operation timing being outside the range of the prescribed value may be indicated by another display format such as changing colors.

FIG. 10 is a diagram showing a display example of the determination result of the actual time difference determination portion 5. In the example of FIG. 10, the prescribed value ΔT2H_AB_offon of the deviation in close-open operation timing D_AB_offon between the valve with valve ID “A” and the valve with valve ID “B”, and the prescribed value ΔT2H_BC_offon of the deviation in close-open operation timing D_BC_offon between the valve with valve ID “B” and the valve with valve ID “C” are set to 8.0 sec.

The actual time difference determination portion 5 determines that the deviation in close-open operation timing D_BC_offon between the valve with valve ID “B” and the valve with valve ID “C” is outside the range of the prescribed value ΔT2H_BC_offon=8.0 sec. by the determination formula of formula (29).

Thus, the determination result output portion 6 displays the IDs “B” and “C” of the valves determined to have the deviation in operation timing outside the range of the prescribed value, and the actual values Tx_B_off=695.0 sec, and Tx_C_on=705.0 sec. used for calculating this deviation in operation timing, in a format different from the determination result where the deviation in operation timing is within the range of the prescribed value (white on black background in the example of FIG. 10). By such display distinction, an operator viewing the display of FIG. 10 may recognize that the deviation in close-open operation timing between the valve with valve ID “B” and the valve with valve ID “C” is outside the range of the prescribed value. FIG. 10 is one example, and the deviation in operation timing being outside the range of the prescribed value may be indicated by another display format such as changing colors.

FIG. 11 is a diagram showing an example in which the determination result of the regular time difference determination portion 4 and the determination result of the actual time difference determination portion 5 are displayed simultaneously. In this case, the display result combines FIG. 9 and FIG. 10. However, regarding the deviation in operation timing of the valve with valve ID “B”, both determination results of the regular time difference determination portion 4 and the actual time difference determination portion 5 indicate that the results are outside the range of the prescribed value.

Thus, the determination result output portion 6 displays, for example, valve ID “B” in a format different from the information of valves where the deviation in operation timing is within the range of the prescribed value in at least one of the determination by the regular time difference determination portion 4 and the determination by the actual time difference determination portion 5. This may notify the operator that both determination results for the valve with valve ID “B” are outside the range of the prescribed value, and may notify the operator of the priority of events that should be addressed. In the example of FIG. 11, diagonal lines slanting downward to the right are applied to the background of the characters to distinguish the display, but notification may be provided by another display format such as changing colors.

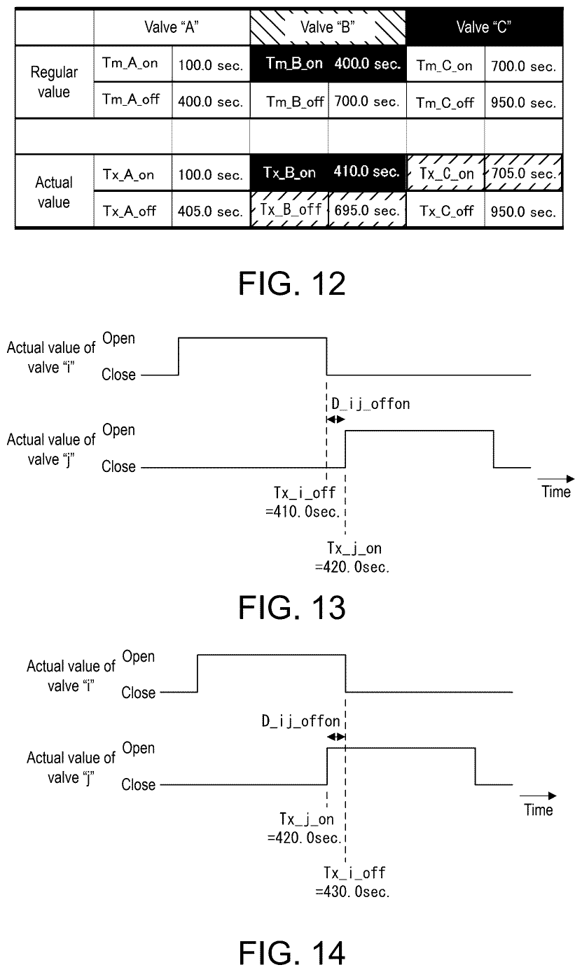

FIG. 12 is a diagram showing another example in which the determination result of the regular time difference determination portion 4 and the determination result of the actual time difference determination portion 5 are displayed simultaneously. The determination results of the regular time difference determination portion 4 and the actual time difference determination portion 5 are the same as in the case of FIG. 11. However, in the example of FIG. 12, the deviation in close-open operation timing D_BC_offon between the valve with valve ID “B” and the valve with valve ID “C” is a more serious event that directly leads to quality degradation due to the collapse of manufacturing process conditions than the deviation in opening operation timing D_B_on of the valve with valve ID “B”, so information indicating that D_BC_offon has higher importance is registered in advance in the management sequence memory portion 2. That is, in the management sequence memory portion 2, definition information of the deviation in operation timing, prescribed values of deviation, and importance information of deviation are registered in advance for each valve ID or each combination of valve IDs.

In the case where the importance of the deviation in close-open operation timing D_BC_offon is higher than the importance of the deviation in opening operation timing D_B_on, the determination result output portion 6 displays the actual values Tx_B_off=695.0 sec. and Tx_C_on=705.0 sec. used for calculating D_BC_offon in a format different from other items, thereby making the importance of the deviation in operation timing understandable. Such display distinction may notify the operator of events with high importance. In the example of FIG. 12, diagonal lines slanting downward to the left are applied to the background of the characters to distinguish the display, but notification may be provided by another display format such as changing colors.

In the example of FIG. 12, the case where determination results indicating that the deviation in operation timing is outside the range of the prescribed value are obtained in both the determination by the regular time difference determination portion 4 and the determination by the actual time difference determination portion 5 has been described. However, it goes without saying that in the case where a plurality of determination results indicating that the deviation in operation timing is outside the range of the prescribed value are obtained in the determination by the regular time difference determination portion 4, or in the case where a plurality of determination results indicating that the deviation in operation timing is outside the range of the prescribed value are obtained in the determination by the actual time difference determination portion 5, the display may be made so that the importance of each determination result can be understood.

It is noted that among the determination formulas of formulas (13) to (36), there are formulas (13), (14), (17), (18), (21), (22), (25), (26), (29), (30), (33), (34) with absolute value symbols, and formulas (15), (16), (19), (20), (23), (24), (27), (28), (31), (32), (35), (36) with the absolute value symbols removed. By using the formulas with the absolute value symbols removed, it is possible to discriminate between cases with high severity and cases without high severity.

For example, regarding a case as shown in FIG. 13, in the case of determining the deviation in close-open operation timing D_ij_offon between the valve with valve ID “i” and the valve with valve ID “j” according to formula (31), since D_ij_offon=410.0-420.0=−10.0 sec. falls below the prescribed value ΔT2H_ij_offon-8.0 sec., D_ij_offon is determined to be within the range of the prescribed value.

On the other hand, regarding a case as shown in FIG. 14, in the case of determining the deviation in close-open operation timing D_ij_offon according to formula (31), since D_ij_offon=430.0-420.0=10.0 sec. exceeds the prescribed value ΔT2H_ij_offon=8.0 sec., D_ij_offon is determined to be outside the range of the prescribed value.

In the case of the closing time point for the valve with valve ID “i” being 400.0 sec. and the opening time point for the valve with valve ID “j” being 420.0 sec., in the case of FIG. 13, the closing timing of the valve with valve ID “i” is delayed, but this is a case without high severity. On the other hand, in the case of FIG. 14, since the closing timing of the valve with valve ID “i” is delayed compared to the opening timing of the valve with valve ID “j”, this is a case with high severity.

Here, the case of FIG. 13 is a case without high severity, and the case of FIG. 14 is a case with high severity, but the opposite case may also be possible. Regarding a case as shown in FIG. 13, in the case of determining the deviation in close-open operation timing D_ij_offon of the valve according to formula (32), since D_ij_offon=410.0-420.0=−10.0 sec. falls below the prescribed value ΔT2L_ij_offon=8.0 sec., D_ij_offon is determined to be outside the range of the prescribed value. Further, regarding a case as shown in FIG. 14, in the case of determining the deviation in close-open operation timing D_ij_offon according to formula (32), since D_ij_offon=430.0-420.0=10.0 sec. exceeds the prescribed value ΔT2L_ij_offon=8.0 sec., D_ij_offon is determined to be within the range of the prescribed value.

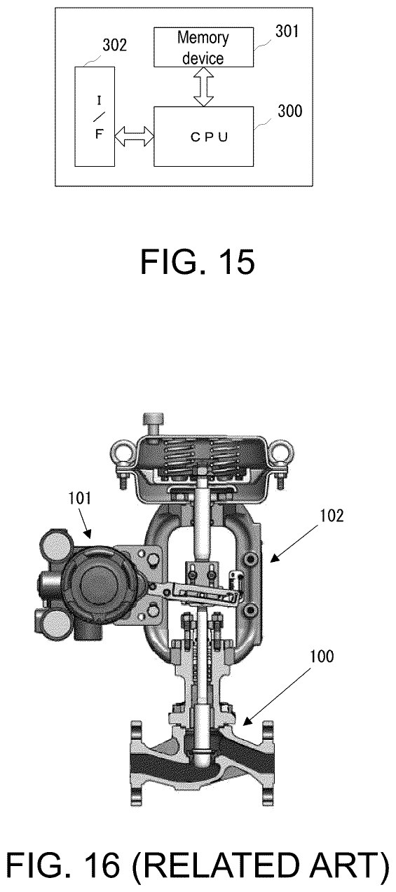

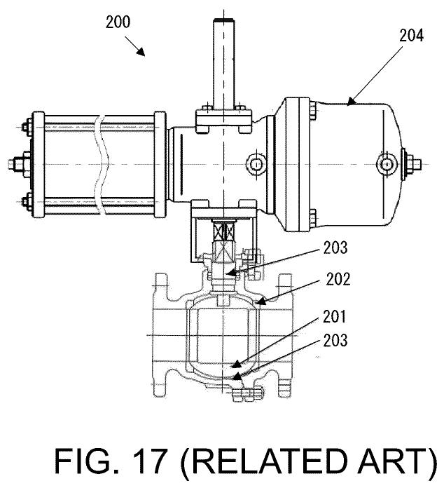

The management system described in this embodiment may be realized by a computer including a CPU (Central Processing Unit), a memory device, and an interface, and a program that controls these hardware resources. A configuration example of this computer is shown in FIG. 15.

The computer includes a CPU 300, a memory device 301, and an interface device (I/F) 302. A controller that controls valves, a display device, and the like are connected to the I/F 302. In such a computer, a program for realizing the management method of the disclosure is stored in the memory device 301. The CPU 300 executes the processing described in this embodiment according to the program stored in the memory device 301.

What is claimed is:

1. A management system comprising:
a management sequence memory portion configured to store, for each valve to be managed or for each combination of valves to be managed among ON-OFF valves controlled by a sequence to be managed, definition information of a deviation in operation timing and a prescribed value of a deviation for an ON-OFF valve to be managed;
an operation result information acquisition portion configured to acquire an actual value of an opening or closing time point of the valve to be managed;
a time difference determination portion configured to calculate a deviation in operation timing for each valve to be managed or for each combination of valves to be managed based on the definition information and an actual value of the opening or closing time point, and to determine whether a deviation in operation timing calculated is within a range of the prescribed value; and
a determination result output portion configured to output a determination result by the time difference determination portion.

2. The management system according to claim 1, wherein
the time difference determination portion is a regular time difference determination portion that calculates, as the deviation in operation timing, a deviation between a time point when a valve should operate and an actual value of a time point when the valve operated for each valve to be managed and determines whether a deviation in operation timing calculated is within a range of the prescribed value.

3. The management system according to claim 2, wherein
the deviation in operation timing is at least one of a deviation between a time point when a valve should open and an actual value of a time point when the valve opened, and a deviation between a time point when a valve should close and an actual value of a time point when the valve closed.

4. The management system according to claim 1, wherein
the time difference determination portion is an actual time difference determination portion that calculates, as the deviation in operation timing, a deviation in operation timing between a first valve and a second valve for each combination of the first valve and the second valve to be managed and determines whether a deviation in operation timing calculated is within a range of the prescribed value.

5. The management system according to claim 4, wherein
the deviation in operation timing is at least one of a deviation between a time point when the first valve opened and a time point when the second valve opened, a deviation between a time point when the first valve opened and a time point when the second valve closed, a deviation between a time point when the first valve closed and a time point when the second valve opened, and a deviation between a time point when the first valve closed and a time point when the second valve closed.

6. The management system according to claim 4, wherein
when deviations in operation timing among three or more valves are to be managed, the management sequence memory portion stores the definition information and the prescribed value for each of different combinations of the first valve and the second valve included in the three or more valves, and
the actual time difference determination portion calculates a deviation in operation timing for each of the different combinations of the first valve and the second valve included in the three or more valves, and determines whether a deviation in operation timing calculated is within a range of a corresponding prescribed value.

7. The management system according to claim 5, wherein
when deviations in operation timing among three or more valves are to be managed, the management sequence memory portion stores the definition information and the prescribed value for each of different combinations of the first valve and the second valve included in the three or more valves, and
the actual time difference determination portion calculates a deviation in operation timing for each of the different combinations of the first valve and the second valve included in the three or more valves, and determines whether a deviation in operation timing calculated is within a range of a corresponding prescribed value.

8. The management system according to claim 1, wherein
the time difference determination portion comprises two portions:
a regular time difference determination portion that calculates, as the deviation in operation timing, a deviation between a time point when a valve should operate and an actual value of a time point when the valve operated for each valve to be managed, and determines whether a deviation in operation timing calculated is within a range of the prescribed value; and
an actual time difference determination portion that calculates, as the deviation in operation timing, a deviation in operation timing between a first valve and a second valve for each combination of the first valve and the second valve to be managed, and determines whether a deviation in operation timing calculated is within a range of the prescribed value, and
the determination result output portion displays at least one of a determination result by the regular time difference determination portion and a determination result by the actual time difference determination portion, and displays a determination result where the deviation in operation timing is outside a range of the prescribed value in a different format from a determination result where the deviation in operation timing is within the range of the prescribed value.

9. The management system according to claim 8, wherein
the determination result output portion displays information of a valve where the deviation in operation timing is outside a range of the prescribed value in both a determination by the regular time difference determination portion and a determination by the actual time difference determination portion, in a different format from information of a valve where the deviation in operation timing is within a range of the prescribed value in at least one of a determination by the regular time difference determination portion and a determination by the actual time difference determination portion.

10. The management system according to claim 8, wherein
the management sequence memory portion stores importance information of the deviation in operation timing together with the definition information and the prescribed value for each valve to be managed or for each combination of valves to be managed, and
when a plurality of determination results where the deviation in operation timing is outside a range of the prescribed value are obtained, the determination result output portion displays a determination result so that an importance of the deviation in operation timing is capable of being understood based on the importance information.

11. A management method comprising:
acquiring an actual value of an opening or closing time point of an ON-OFF valve to be managed among ON-OFF valves controlled by a sequence to be managed;
referring to a management sequence memory portion that stores, for each valve to be managed or for each combination of valves to be managed, definition information of a deviation in operation timing and a prescribed value of a deviation for the valve to be managed and calculating a deviation in operation timing for each valve to be managed or for each combination of valves to be managed based on the definition information and the actual value of the opening or closing time point;
determining whether a deviation in operation timing calculated is within a range of the prescribed value; and
outputting a determination result.
